(19) United States
(12) Patent Application Publication
(10) Pub. No.: US 2024/0388094 A1
(43) Pub. Date: Nov. 21, 2024

(54) LOAD RECOVERY METHOD AND SYSTEM FOR POWER DISTRIBUTION NETWORK CONSIDERING STANDBY ENERGY STORAGE OF 5G BASE STATIONS

(71) Applicant: SOUTHEAST UNIVERSITY, Nanjing (CN)

(72) Inventors: Meng Song, Nanjing (CN); Yunting Yao, Nanjing (CN); Ciwei Gao, Nanjing (CN); Qinran Hu, Nanjing (CN); Yifei Wang, Nanjing (CN)

(21) Appl. No.: 18/668,013

(22) Filed: May 17, 2024

Related U.S. Application Data
(63) Continuation of application No. PCT/CN2023/096218, filed on May 25, 2023.

(30) Foreign Application Priority Data
May 16, 2023 (CN) 202310550359.5

(51) Int. Cl. H02J 3/28; H02J 3/38; H02J 7/00; H02J 9/06

(52) U.S. Cl. CPC H02J 3/28; H02J 3/381; H02J 7/0048; H02J 7/00712; H02J 9/062; H02J 2203/10; H02J 2203/20; H02J 2300/24

(57) ABSTRACT

A load recovery method and system for a power distribution network (PDN) considering standby energy storage of 5G base stations (BSs) is disclosed, falling within the field of power systems. The method includes constructing a basic model of a 5G BS; evaluating a schedulable capacity of a standby battery of the 5G BS; modeling operation behaviors of the 5G BS at different stages after a power outage of the PDN; using a double-layer optimization model to describe the load recovery of the PDN for the 5G BS on the basis of the correlation between the operation behaviors of the 5G BS and a load recovery process in practice; and solving the double-layer optimization model to complete the load recovery of a PDN system. The problem that no research has focused on how to use the 5G BSs to enhance the resilience of PDN is solved.

### CROSS-REFERENCE TO RELATED APPLICATIONS

This application is a continuation of PCT/CN2023/096218, filed May 25, 2023and claims priority of Chinese Patent Application No. 202310550359. 5, filed on May 16, 2023, the entire contents of which are incorporated herein by reference.

### TECHNICAL FIELD

The present disclosure relates to the technical field of power systems, and in particular, to a load recovery method and system for a power distribution network (PDN) considering standby energy storage of 5G base stations (BSs).

### BACKGROUND

As a communication infrastructure, a 5G BS meets the communication requirements of high speed and low delay, so it has been rapidly developed. The 5G BS consumes a large amount of power and has the potential of flexible scheduling, which is very suitable for serving a power grid. The reasons for this are as follows. Firstly, the power consumption of a single 5G BS is about 3-4 times that of a single 4G BS; secondly, the effective communication distance of the 5G BS becomes shorter, and more BSs need to be deployed to ensure network coverage; and thirdly, the 5G BS is equipped with standby batteries, some of which are idle and can be used to provide flexible power services. After a power outage, the system scheduling often realizes load recovery by renewable energy, thereby causing fluctuations in electric power supply, which may lead to voltage out-of-limits and other consequences. In order to improve the resilience of PDN, the flexibility of the system needs to be improved. The 5G BS has flexible power resources, showing great potential in load recovery, which can speed up load recovery by regulating its operation mode.

However, no research has focused on how to use the 5G BSs to enhance the resilience of PDN. In most literature, the load of PDN nodes is assumed to be constant or continuously adjustable, but its operation mode, including the relationship among resilience, available time and outage time, is not discussed. With the development of the Internet of things and intelligent controllers, many novel models begin to have the ability to self-adjustment, which makes operating characteristics of the load change with load recovery decisions.

### SUMMARY

### I. Technical Problem to be Solved

In view of the deficiencies of the prior art, the present disclosure provides a load recovery method and system for a PDN considering standby energy storage of 5G BSs, and solves the problem that no research has focused on how to use the 5G BSs to enhance the resilience of PDN.

### II. Technical Solution

In order to achieve the above object, the present disclosure provides the following technical solutions. A load recovery method for a PDN considering standby energy storage of 5G BSs includes:
constructing a basic model of a 5G BS, including constructing an energy consumption model of the 5G BS on the basis of a 5G BS composition structure and a working state, and establishing a coordinated operation model among 5G BSs on the basis of the distribution of the 5G BSs, in which the 5G BS composition structure includes electric power supply and a communication device, the electric power supply including a power source and a standby battery;
evaluating a schedulable capacity of the standby battery of the 5G BS, including calculating a minimum standby capacity of the standby battery, and evaluating a charging state of the standby battery;
modeling operation behaviors of the 5G BS at different stages after a power outage of the PDN, in which the different stages include: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level;
using a double-layer optimization model to describe the load recovery of the PDN for the 5G BS on the basis of the correlation between the operation behaviors of the 5G BS and a load recovery process in practice, in which the double-layer optimization model includes an upper layer load recovery model and a lower layer 5G BS optimal scheduling model; and
solving the double-layer optimization model to complete the load recovery of a PDN system.

Preferably, the energy consumption model of the 5G BS is as follows:

$${P}_{i , t}^{B} = \{ \begin{matrix}{P}_{i , t}^{B , a} + γ {P}_{i , t}^{tr} , {ε}_{i , t} = 1 ( active ) \\ {P}_{i , t}^{B , b} , {ε}_{i , t} = 0 ( sleep )\end{matrix}$$

where P_{i,t}^{B} refers to power consumption of the 5G BS in a t period, P_{i,t}^{tr} represents transmission power, ε_{i,t} represents a state, γ represents a constant term coefficient, a constraint P_{i,t}^{B,a}>P_{i,t}^{B,b} exists, representing that power consumption of the 5G BS in a sleep mode is much less than that in an active mode.

Preferably, the construction of the coordinated operation model among the 5G BSs is as follows:
transferring a communication load among multiple 5G BSs to realize power migration, the connection between a client and the 5G BS being constrained in the migration process:

$$\begin{matrix}{\sum }_{i ϵ {I}_{m}} {C}_{i , m , t} = 1 \\ {C}_{i , m , t} \leq {ε}_{i , t}\end{matrix}$$

where C_{i,m,t} refers to a connection state of the client.

Preferably, the calculating a minimum standby capacity of the standby battery specifically includes:

$$\begin{matrix}{R}_{i , t} = {\int }_{t}^{t + D} {P}_{i , t}^{B} d t \\ {R}_{i , t} = {P}_{i , t}^{B} \cdot D\end{matrix}$$

where R_{i,t} is the minimum standby energy of the standby battery, and D is a standby duration.

Preferably, the evaluating a charging state of the standby battery specifically includes:
defining the charging state of the standby battery according to the remaining capacity R_{i,t} of the standby battery and a maximum capacity Eᵢ of the standby battery, SOC_{i,t}^{min} being subject to:

$${SOC}_{i , t}^{min} = {R}_{i , t} / {E}_{i} .$$

Preferably, in the first stage, the operation behavior of the standby battery is constrained by:

$$\begin{matrix}0 \leq {P}_{i , t}^{d l} \leq {z}_{i , t}^{d l} \cdot {P}_{i}^{d , max} \\ {z}_{i , t}^{d l} \leq 1 - {s}_{i , t}^{D} \\ {SOC}_{i , t + 1}^{l} = {SOC}_{i , t}^{l} - {P}_{i , t}^{d l} \cdot Δ t / {η}_{i}^{d} \\ {SOC}_{i , t + 1}^{l} \geq {SOC}_{i}^{min} \\ {SOC}_{i , 0}^{l} = {SOC}_{i}^{int}\end{matrix}$$

where P_{i,t}^{dl} is charge-discharge power of the BS in the first stage, Pᵢ^{d,max} is the maximum discharging power of the standby battery, z_{i,t}^{dl} is a discharging state of the standby battery in the first stage, s_{i,t}^{D} is a load state, SOC_{i,t}^{l} is a charging state of the standby battery, ηᵢ^{d} represents discharging efficiency of the standby battery, SOCᵢ^{min} represents a minimum charge capacity of the standby battery, and SOCᵢ^{int} is an initial energy storage level of the standby battery,

$$0 \leq {P}_{i , t}^{B} - {P}_{i , t}^{d l} \leq {s}_{i , t}^{D} \cdot M$$

where M is a big number;
in the second stage, operation decisions of the standby battery are described as follows:

$$\begin{matrix}{δ}_{i} = [ {s}_{i , 1}^{D} , {s}_{i , 2}^{D} - {s}_{i , 1}^{D} , … , {s}_{i , T}^{D} - {s}_{i , T - 1}^{D} ] \\ {SOC}_{i , t}^{l} = [ {SOC}_{i , 1}^{l} , {SOC}_{i , 2}^{l} , … , {SOC}_{i , t}^{l} , … , {SOC}_{i , T}^{l} ] \\ {δ}_{i} \cdot {( SO {C}_{i , t}^{l} )}^{T} + {P}_{i}^{c , max} {\sum }_{t ∈ T} ( {s}_{i , t}^{D} - {z}_{i , t} ) Δ t / {E}_{i} \geq {SOC}_{i}^{i n t} \\ {δ}_{i} \cdot {( SO {C}_{i , t}^{l} )}^{T} + {P}_{i}^{c , max} [ {\sum }_{t ∈ T} ( {s}_{i , t}^{D} - {z}_{i , t} ) - 1 ] Δ t / {E}_{i} \leq {SOC}_{i}^{i n t} \\ {P}_{i}^{e} {\sum }_{t ∈ T} ( {s}_{i , t}^{D} - {z}_{i , t} ) Δ t / {E}_{i} = {SOC}_{i}^{a} - {δ}_{i} \cdot {( {SOC}_{i , t}^{l} )}^{T}\end{matrix}$$

where δᵢ is a load state in different time periods, Pᵢ^{c,max} is the maximum charging power of the standby battery, z_{i,t} is a schedulable state of the standby battery, and Pᵢ^{e} is charging power of the standby battery; and
in the third stage, an available time of the standby battery is as follows:

$$\begin{matrix}{Z}_{i , t + 1} \geq {Z}_{i , t} \\ {Z}_{i , t} \leq {s}_{i , t}^{D}\end{matrix}$$

in which the operation behavior of the standby battery meets the following requirements:

$$\begin{matrix}{P}_{i , t}^{c d} = {P}_{i , t}^{c u} - {P}_{i , t}^{d u} \\ 0 \leq {P}_{i , t}^{c u} \leq {z}_{i , t}^{c u} \cdot {P}_{i}^{c , max} \\ 0 \leq {P}_{i , t}^{d u} \leq {z}_{i , t}^{d u} \cdot {P}_{i}^{d , max} \\ {z}_{i , t}^{c u} + {z}_{i , t}^{d u} \leq {Z}_{i , t} \\ {SOC}_{i , 0}^{u} = {SOC}_{i}^{i n t} \\ {SOC}_{i , t + 1}^{u} = {SOC}_{i , t}^{u} + {η}_{i}^{c} \cdot {P}_{i , t}^{c u} \cdot Δ t - {P}_{i , t}^{d u} \cdot Δ t / {η}_{i}^{d} \\ {SOC}_{i , t}^{min\_r} \leq {SOC}_{i , t + 1}^{u} \leq {SOC}_{i}^{max} \\ {SOC}_{i , t}^{min\_r} = {P}_{i , t}^{B} \cdot D / {E}_{i} \\ {SOC}_{i , T}^{u} = {SOC}_{i}^{i n t}\end{matrix}$$

where P_{i,t}^{cd} represents charge-discharge power of the standby battery of the BS in the third stage, P_{i,t}^{cu} and P_{i,t}^{du} represent charging and discharging power of the standby battery of the BS in the third stage, z_{i,t}^{cu} and z_{i,t}^{du} represent charge-discharge states of the standby battery in the third stage, and SOC_{i,t}^{u} represents a charging state of the standby battery in the third stage.

Preferably, the construction of the upper layer load recovery model is specifically as follows:
the load recovery including an objective function and constraint conditions, in which the objective function is to maximize the load recovered after the power outage:

$$max {\sum }_{t ∈ T} {\sum }_{i ∈ L} {ω}_{i} {s}_{i , t}^{D} ( {P}_{i , t}^{D} + {P}_{i , t}^{B} )$$

where ωᵢ is a load weighting coefficient; and
the constraint conditions including:
a power flow constraint:

$$\begin{matrix}{U}_{i , t} = {U}_{j , t} - 2 ( {r}_{j i} {P}_{ji , t}^{L} + {x}_{j i} {Q}_{ji , t}^{L} ) + ( {r}_{j i}^{2} + {x}_{j i}^{2} ) {I}_{ji , t}^{L} \\ {I}_{ji , t}^{L} = \frac{{( {P}_{ji , t}^{L} )}^{2} + {( {Q}_{ji , t}^{L} )}^{2}}{{U}_{j , t}} \\ {P}_{ji , t}^{L} = {\sum }_{k ∈ K ( i ; )} {P}_{k , t}^{L} + {s}_{i , t}^{D} {P}_{i , t}^{D} + {s}_{i , t}^{D} {P}_{i , t}^{B} + ( {s}_{i , t}^{D} - {z}_{i , t} ) {P}_{i}^{e} + {P}_{i , t}^{c d} + {P}_{i , t}^{PV} - {P}_{i , t}^{G} \\ {Q}_{ji , t}^{L} = {\sum }_{k ∈ K ( i ; )} {Q}_{k , t}^{L} + {s}_{i , t}^{D} {Q}_{i , t}^{D} + {s}_{i , t}^{D} {Q}_{i , t}^{B} + ( {s}_{i , t}^{D} - {z}_{i , t} ) {P}_{i}^{e} + {Q}_{i , t}^{c d} - {Q}_{i , t}^{P V} - {Q}_{i , t}^{G}\end{matrix}$$

where U_{i,t} is a node voltage; rⱼᵢ and xⱼᵢ are a line impedance and a reactance, respectively; P_{ji,t}^{L} and Q_{ji,t}^{L} are active and reactive power of a line; I_{ji,t}^{L} is a current; Q_{ji,t}^{L}, Q_{i,t}^{PV}, Q_{k,t}^{L} , and Q_{i,t}^{G} are reactive power of the line, photovoltaic (PV) reactive power, reactive power of a line connected to the BS and reactive power of a distributed generator (DG), respectively; s_{i,t}^{D}P_{i,t}^{B} represents power of the 5G BS; (s_{i,t}^{D}−z_{i,t})Pᵢ^{e} is charging power of the standby battery in the second stage; P_{i,t}^{cd} is charging/discharging power of the standby battery in the third stage; and P_{i,t}^{B}, z_{i,t} is and Pᵢ^{e} describe operation behaviors of the 5G BS;
a formula

$${I}_{ji , t}^{L} = \frac{{( {P}_{ji , t}^{L} )}^{2} + {( {Q}_{ji , t}^{L} )}^{2}}{{U}_{j , t}}$$

being non-convex and the relaxation being:

$${I}_{ji , t}^{L} \geq \frac{{( {P}_{ji , t}^{L} )}^{2} + {( {Q}_{ji , t}^{L} )}^{2}}{{U}_{j , t}}$$

a sequence constraint: continuous power supply being maintained during recovery once the load is energized:

$${s}_{i , t + 1}^{D} \geq {s}_{i , t}^{D}$$

a voltage constraint: a node voltage remaining within its constraint:

$${U}_{i}^{min} \leq {U}_{i , t} \leq {U}_{i}^{max}$$

a transmission line capacity constraint: power flow in a distribution network being constrained by line heat capacity:

$$- {P}_{k}^{L \_ max} \leq {P}_{k , t}^{L} \leq {P}_{k}^{L \_ max}$$

$$- {Q}_{k}^{L \_ max} \leq {Q}_{k , t}^{L} \leq {Q}_{k}^{L \_ max}$$

a substation capacity constraint: a recoverable capacity constraint of a substation being shown in the following formula, where Pₜ^{sub} and Qₜ^{sub} represent upper limits of active and reactive power of the BS:

$$0 \leq {P}_{1 , t}^{L} \leq {P}_{t}^{s u b} , 0 \leq {Q}_{1 , t}^{L} \leq {Q}_{t}^{s u b}$$

a PV constraint: PV active and reactive power being maintained as:

$${( {P}_{i , t}^{P V} )}^{2} + {( {Q}_{i , t}^{P V} )}^{2} \leq {( {S}_{i}^{P V} )}^{2}$$

a DG constraint: an operation constraint for the DG including a DG capacity and a climbing constraint:

$$- {s}_{i , t}^{G} {P}_{i , t}^{G \_ min} \leq {P}_{i , t}^{G} \leq {s}_{i , t}^{G} {P}_{i , t}^{G \_ max} , i ∈ G$$

$$- {s}_{i , t}^{G} {Q}_{i , t}^{G \_ min} \leq {Q}_{i , t}^{G} \leq {s}_{i , t}^{G} {Q}_{i , t}^{G \_ max} , i ∈ G$$

$$- {P}_{i}^{ramp} \leq {P}_{i , t + 1}^{G} - {P}_{i , t}^{G} \leq {P}_{i}^{ramp} , i ∈ G$$

where s_{i,t}^{G} represents a 0-1 variable of a DG state, and Pᵢ^{ramp} represents a climbing constraint of the DG; and
an energy storage constraint.

Preferably, an objective function of the lower layer 5G BS optimal scheduling model is designed to minimize power consumption of the 5G BS,

$$min {\sum }_{t ∈ T} {\sum }_{i ∈ L} {P}_{i , t}^{B}$$

having constraint conditions:
a power consumption constraint of the 5G BS:

$${P}_{i , t}^{B} \leq {P}_{i , t}^{B , a} + γ {P}_{i , t}^{tr} + ( 1 - {ε}_{i , t} ) \cdot M$$

$${P}_{i , t}^{B} \geq {P}_{i , t}^{B , a} + γ {P}_{i , t}^{tr} - ( 1 - {ε}_{i , t} ) \cdot M$$

$${P}_{i , t}^{B} \leq {P}_{i , t}^{B , b} + {ε}_{i , t} \cdot M$$

$${P}_{i , t}^{B} \geq {P}_{i , t}^{B , b} - {ε}_{i , t} \cdot M$$

where Put represents transmission power of the 5G BS;
a BS transmission power constraint:

$${P}_{i , t}^{tr} = {\sum }_{m ∈ {M}_{i}} {C}_{i , m , t} {P}_{i , m , t}^{tr}$$

$${P}_{i , t}^{tr} \leq {P}^{max}$$

$${\sum }_{i ∈ {I}_{m}} {C}_{i , m , t} = 1$$

$${C}_{i , m , t} \leq {ε}_{i , t}$$

where C_{i,m,t} represents a 0-1 variable of a connection state of a user;
a BS bandwidth constraint:

$${B}_{i , t} = {\sum }_{m ∈ {M}_{i}} {C}_{i , m , t} B$$

$${B}_{i , t} \leq {B}^{max}$$

where B represents a bandwidth, and B^{max} is the maximum BS bandwidth; and
a customer communication satisfaction constraint:

$${S}_{i , m , t} = \frac{{P}_{i , m , t}^{tr}}{{N}_{0}}$$

$${ϑ}_{i , m , t} = B {log}_{2} ( 1 + {S}_{i , m , t} )$$

$${ϑ}_{i , m , t} \geq {ϑ}_{i , m}^{min} {C}_{i , m , t}$$

where N₀ is a power spectral density, and S_{i,m,t} is a signal-to-noise ratio (SNR) used for characterizing communication quality.

Preferably, the solving the double-layer optimization model to complete the load recovery of a PDN system specifically includes:
the double-layer optimization model being:

$$min {ax}_{u} + b {y}_{l} + c {r}_{l}$$

$$s . t . {A}^{1} {x}_{u} + {V}^{1} {y}_{l} + {F}^{1} {r}_{l} = v$$

$${A}^{2} {x}_{u} + {V}^{2} {y}_{l} + {F}^{2} {r}_{l} \leq m$$

$$( {y}_{l} , {r}_{l} ) ∈ arg min \{ d {y}_{l} :$$

$$s . t . {H}^{1} {x}_{u} + {J}^{1} {y}_{l} + {O}^{1} {r}_{l} = w$$

$${H}^{2} {x}_{u} + {J}^{2} {y}_{l} + {O}^{2} {r}_{l} \leq h$$

$${y}_{l} \geq 0 , {r}_{l} ∈ \{ 0 , 1 \}$$

where xᵤ represents an upper layer decision variable appearing in a lower layer problem constraint condition; yₗ and rₗ are continuous and discrete decision variables at a lower layer, respectively; and a, b, c, A, V, F, v, m, w, h, H, J, O and d represent constant terms in a compact form of the optimization model;
assuming that when the upper layer decision variable is x, a unique optimal solution of a lower layer problem is y′ₗ and r′ₗ, the problem being reconstructed as follows:

$$min {ax}_{u} + b {y}_{l}^{′} + {cr}_{l}^{′}$$

$$s . t . {A}^{1} {x}_{u} + {V}^{1} {y}_{l}^{′} + {F}^{1} {r}_{l}^{′} = v$$

$${A}^{2} {x}_{u} + {V}^{2} {y}_{l}^{′} + {F}^{2} {r}_{l}^{′} \leq m$$

$${H}^{1} {x}_{u} + {J}^{I} {y}_{l}^{′} + {O}^{1} {r}_{l}^{′} = w$$

$${H}^{2} {x}_{u} + {J}^{2} {r}_{l}^{′} + {O}^{2} {r}_{l}^{′} \leq h$$

$${y}_{l}^{′} \geq 0 , {r}_{l}^{′} ∈ \{ 0 , 1 \}$$

$$d {y}_{l}^{′} \leq min \{ d {y}_{l} :$$

$${H}^{1} {x}_{u} + {J}^{1} {y}_{l} + {O}^{1} {r}_{l} = w$$

$${H}^{2} {x}_{u} + {J}^{2} {y}_{l} + {O}^{2} {r}_{l} = h$$

$${y}_{l} \geq 0 , {r}_{l} ∈ \{ 0 , 1 \} \}$$

the lower layer problem being reorganized as follows:

$$d {y}_{l}^{′} \leq min \{ d {\overline{y}}_{l} :$$

$${H}^{1} {x}_{u} + {J}^{1} {\overline{y}}_{l} + {O}^{1} {\overline{r}}_{l} = w$$

$${H}^{2} {x}_{u} + {J}^{2} {\overline{y}}_{l} + {O}^{2} {\overline{r}}_{l} \leq h$$

$${\overline{y}}_{l} \geq 0 \} , ∀ {\overline{r}}_{l} ∈ r$$

where r represents a set of rₗ;

$$SP 1 : {φ}_{l} ( {x}_{u}^{*} ) = min {dy}_{l}$$

$$s . t . {H}^{1} {x}_{u}^{*} + {J}^{1} {y}_{l} + {O}^{1} {r}_{l} = w : {χ}_{1}$$

$${H}^{2} {x}_{u}^{*} + {J}^{2} {y}_{l} + {O}^{2} {r}_{l} \leq h : {μ}_{l}$$

$${y}_{l} \geq 0 , {r}_{l} ∈ r$$

SP2 being set to characterize an upper layer model:

$$SP 2 : {φ}_{u} ( {x}_{u}^{*} ) = min {ax}_{u}^{*} + b {y}_{l} + c {r}_{l}$$

$$s . t . {H}^{1} {x}_{u}^{*} + {J}^{1} {y}_{l} + {O}^{1} {r}_{l} = w : {χ}_{1}$$

$${H}^{2} {x}_{u}^{*} + {J}^{2} {y}_{l} + {O}^{2} {r}_{l} \leq h : {μ}_{l}$$

$${y}_{l} \geq 0 , {r}_{l} ∈ r , d {y}_{l} \leq {φ}_{l} ( {x}_{u}^{*} ) ;$$

the transformation being performed by the duplication of a lower layer variable and constraint conditions, the specific value substitution of the lower layer problem and the addition of Karush-Kuhn-Tucker (KKT) conditions:

$$ψ = min {ax}_{u} + b {y}_{l}^{′} + {cr}_{l}^{′}$$

$$s . t . {A}^{1} {x}_{u} + {V}^{1} {y}_{l}^{′} + {F}^{1} {r}_{l}^{′} = v$$

$${A}^{2} {x}_{u} + {V}^{2} {y}_{l}^{′} + {F}^{2} {r}_{l}^{′} \leq m$$

$${H}^{1} {x}_{u} + {J}^{1} {y}_{l}^{′} + {O}^{1} {r}_{l}^{′} = w$$

$${H}^{2} {x}_{u} + {J}^{2} {r}_{l}^{′} + {O}^{2} {r}_{l}^{′} \leq h$$

$${y}_{l}^{′} \geq 0 , {r}_{l}^{′} ∈ \{ 0 , 1 \}$$

$$d {y}_{l}^{′} \leq min \{ d {y}_{l} :$$

$${H}^{1} {x}_{u} + {J}^{1} {y}_{l} + {O}^{1} {r}_{l} = w$$

$${H}^{2} {x}_{u} + {J}^{2} {y}_{l} + {O}^{2} {r}_{l} \leq h$$

$${y}_{l} \geq 0 , {r}_{l} ∈ \{ 0 , 1 \} \}$$

$${H}^{1} {x}_{u} + {J}^{1} {\hat{y}}_{l} + {O}^{1} {\hat{r}}_{l} = w$$

$$d {y}_{l}^{′} \leq d {\hat{y}}_{l}$$

$$0 \leq {μ}_{l} ⊥ h - ( {H}^{2} {x}_{u} + {J}^{2} {\hat{y}}_{l} + {O}^{2} {\hat{r}}_{l} ) \geq 0$$

$$0 \leq {\hat{y}}_{l} ⊥ d + {J}^{1} {χ}_{l} + {J}^{2} {μ}_{l} \geq 0 .$$

In a second aspect, a load recovery system for a PDN considering standby energy storage of 5G BSs is provided, including:
a model construction module, configured to construct a basic model of a 5G BS, including constructing an energy consumption model of the 5G BS on the basis of a 5G BS composition structure and a working state, and establishing a coordinated operation model among 5G BSs on the basis of the distribution of the 5G BSs, in which the 5G BS composition structure includes electric power supply and a communication device, the electric power supply including a power source and a standby battery;
an evaluation module, configured to evaluate a schedulable capacity of the standby battery of the 5G BS, including calculating a minimum standby capacity of the standby battery, and evaluating a charging state of the standby battery;
a processing module, configured to model operation behaviors of the 5G BS at different stages after a power outage of the PDN, in which the different stages include: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level;
an optimization module, configured to use a double-layer optimization model to describe the load recovery of the PDN for the 5G BS on the basis of the correlation between the operation behaviors of the 5G BS and a load recovery process in practice, in which the double-layer optimization model includes an upper layer load recovery model and a lower layer 5G BS optimal scheduling model; and
a solution module, configured to solve the double-layer optimization model to complete the load recovery of a PDN system.

### III. Advantageous Effects

According to the load recovery method and system for PDN considering standby energy storage of 5G BSs of the present disclosure, in view of the problem that there is no accurate modeling and analysis on the operation mode and load recovery process of the load in the PDN, a double-layer optimization model for load recovery of the PDN for the 5G BSs is designed based on the evolution of operation behaviors of the 5G BSs. The time coupling relationship between operation behaviors and outage time of the 5G BSs is analyzed and modeled. The original non-convex optimization model for load recovery of PDN is transformed into a double-layer mixed integer programming problem and solved by a column-and-constraints generation (CCG) algorithm. In this way, when the power consumption of the 5G BSs is minimized after the power outage, the recovered load can reach the maximum target.

### BRIEF DESCRIPTION OF THE DRAWINGS

FIG. 1 is a schematic structural diagram of the present disclosure;

FIG. 2 is a diagram of the present disclosure;

FIG. 3 is a diagram of a 5G BS composition structure according to an example of the present disclosure;

FIG. 4 is a diagram of multiple 5G BSs in a distribution network system according to an example of the present disclosure;

FIG. 5 is a three-stage diagram of the change of an operating state of the 5G BS according to an example of the present disclosure;

FIG. 6 is an operation diagram of the 5G BS in the first stage according to an example of the present disclosure;

FIG. 7 is an operation diagram of the 5G BS in the second stage according to an example of the present disclosure;

FIG. 8 is an operation diagram of the 5G BS in the third stage according to an example of the present disclosure;

FIG. 9 is an architecture diagram of the load recovery of the 5G BS according to an example of the present disclosure; and

FIG. 10 is a computational flow chart for solving a double-layer mixed integer problem according to an example of the present disclosure.

### DETAILED DESCRIPTION

Technical solutions in examples of the present disclosure are described clearly and completely in the following with reference to the attached drawings of the present disclosure. Obviously, all the described examples are only some, rather than all examples of the present disclosure. Based on the examples in the present disclosure, all other examples obtained by those skilled in the art without creative efforts belong to the scope of protection of the present disclosure.

### EXAMPLES

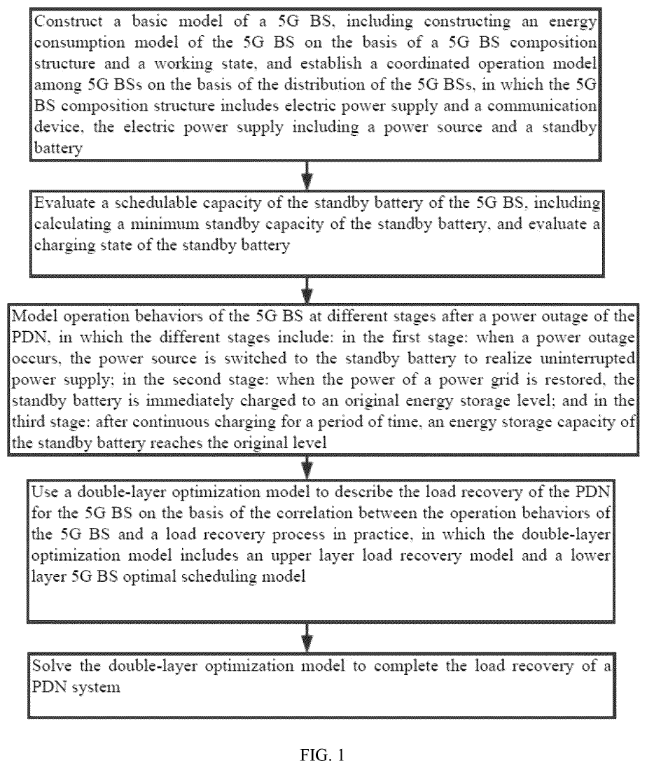

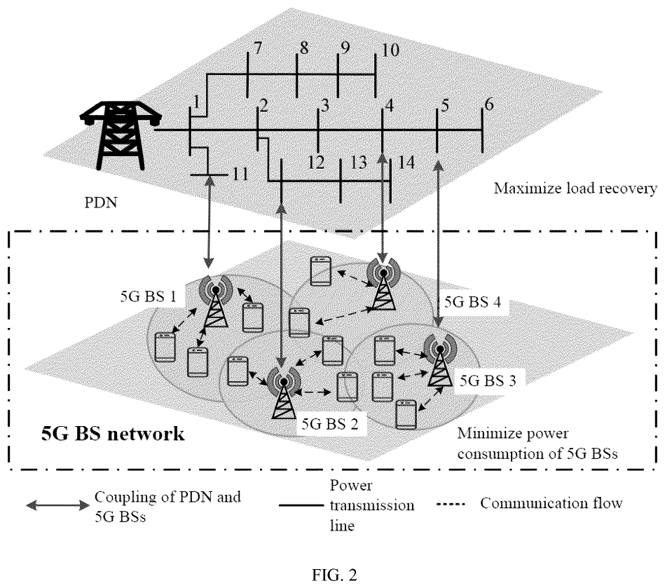

As shown in FIGS. 1 and 2, an example of the present disclosure provides a load recovery method for a PDN considering standby energy storage of 5G BSs, including the following steps.

A basic model of a 5G BS is constructed, including constructing an energy consumption model of the 5G BS on the basis of a 5G BS composition structure and a working state, and a coordinated operation model among 5G BSs is established on the basis of the distribution of the 5G BSs, in which the 5G BS composition structure includes electric power supply and a communication device, the electric power supply including a power source and a standby battery.

A schedulable capacity of the standby battery of the 5G BS is evaluated, including calculating a minimum standby capacity of the standby battery, and evaluating a charging state of the standby battery.

Operation behaviors of the 5G BS at different stages after a power outage of the PDN are modeled, in which the different stages includes: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level.

A double-layer optimization model is used to describe the load recovery of the PDN for the 5G BS on the basis of the correlation between the operation behaviors of the 5G BS and a load recovery process in practice, in which the double-layer optimization model includes an upper layer load recovery model and a lower layer 5G BS optimal scheduling model.

The double-layer optimization model is solved to complete the load recovery of a PDN system.

The specific implementation steps of the method include the following.

A basic model of a 5G BS is constructed.

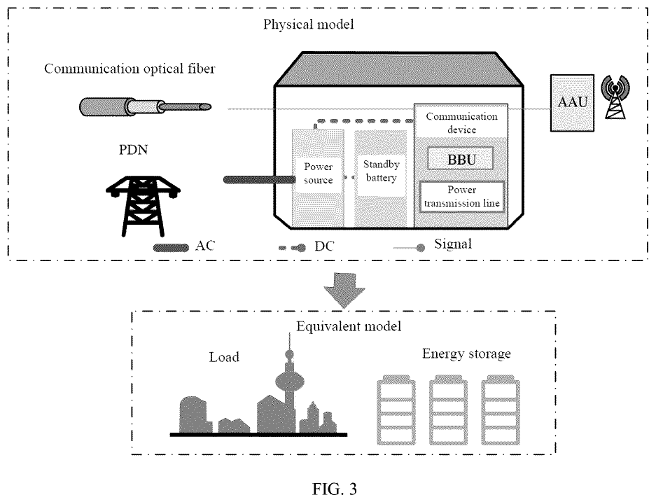

(1) A component device model of a 5G BS is constructed, including electric power supply and a communication device. The electric power supply device is divided into a power source and a standby battery. The former serves as an interface between the PDN and the 5G BS, supplying power to the communication device/standby battery under normal operation of the PDN; and the latter is used to supply power to the communication device when the PDN fails. The communication device includes an active antenna unit (AAU) and a transmission and baseband unit (BBU). These communication devices are used for sending/receiving wireless signals, processing digital signals and transmitting signals to a 5G network, as shown in FIG. 3.

(2) An energy consumption model of the 5G BS is constructed, in which the power consumption of the 5G BS is closely related to its working state, an expression being:

$${P}_{i , t}^{B} = \{ \begin{matrix}{P}_{i , t}^{B , a} + γ {P}_{i , t}^{tr} , {ε}_{i , t} = 1 ( active ) \\ {P}_{i , t}^{B , b} , {ε}_{i , t} = 0 ( sleep )\end{matrix} \qquad ( 1 )$$

where P_{i,t}^{B} refers to power consumption of the 5G BS in a t period, P_{i,t}^{tr} represents transmission power, ε_{i,t} represents a state, γ represents a constant term coefficient, a constraint P_{i,t}^{B,a}>P_{i,t}^{B,b} exists, representing that power consumption of the 5G BS in a sleep mode is much less than that in an active mode.

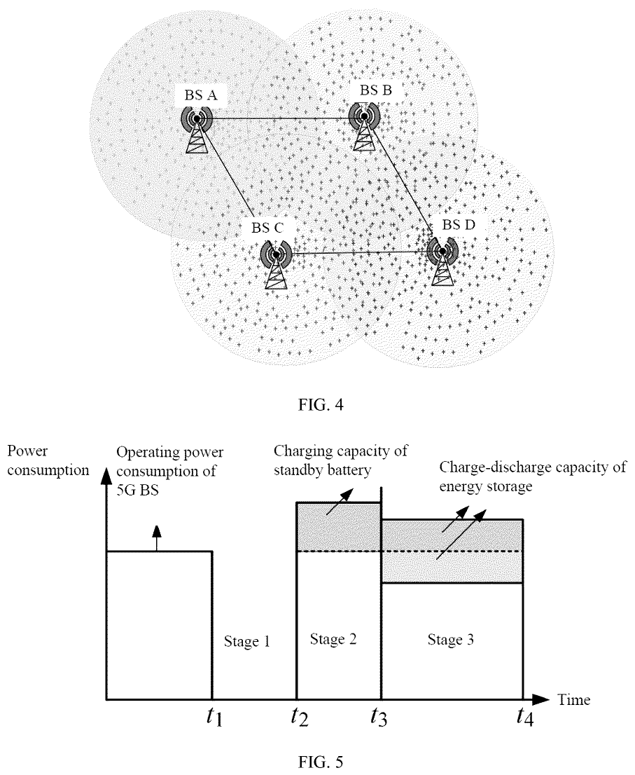

(3) A coordinated operation model between the 5G BSs is constructed. In order to provide clients with high-quality communication services, 5G BSs in a PDN are densely distributed, and the communication coverage is overlapping. Therefore, it is possible to transfer a communication load among a plurality of 5G BSs to realize power migration. For example, if a BS A has less communication load, its customer may transition to a BS B, and then the BS A will be switched to a sleep state to save power consumption, as shown in FIG. 4.

In the communication-energy flow migration process, the connection between a client to the 5G BS is constrained:

$${Σ}_{i ϵ {I}_{m}} {C}_{i , m , t} = 1 \qquad ( 2 a )$$

$${C}_{i , m , t} \leq {ε}_{i , t} \qquad ( 2 b )$$

where C_{i,m,t} refers to a connection state of the client (1 represents connected, and 0 represents not connected).

A schedulable capacity of the standby battery of the 5G BS is evaluated, including the following steps.

(1) A minimum standby capacity of the standby battery is modeled. The standby battery needs to provide the shortest power supply time for the 5G BS in case of power outage to ensure high reliability. In order to meet the requirements for uninterrupted power supply, the minimum standby energy R_{i,t} of the standby battery is calculated as follows, D being a standby duration:

$${R}_{i , t} = {\int }_{t}^{t + D} {P}_{i , t}^{B} dt \qquad ( 3 a )$$

Considering that the characterization of D according to an actual operating state of a distribution network side is not the focus of this paper, D is assumed to be a fixed value, and (3a) is rewritten as:

$${R}_{i , t} = {P}_{i , t}^{B} \cdot D \qquad ( 3 b )$$

(2) A charging state of the standby battery is evaluated, which is defined on the basis of a remaining capacity R_{i,t} of the standby battery and a maximum capacity Eᵢ of the standby battery, SOC_{i,t}^{min} being subject to:

$$S O {C}_{i , t}^{min} = {R}_{i , t} / {E}_{i} \qquad ( 4 )$$

Operation behaviors of the 5G BS at different stages after power outage of the PDN are modeled (Please refer to FIGS. 5-8).

When the PDN fails, the 5G BS will lose the external power source and the standby battery will be switched to supply power to the communication device. As less power is stored by the standby battery during a power outage, power from the PDN may be used to charge the standby battery and support the communication device after load recovery. After a period of time, the standby battery will have sufficient capacity to serve the power grid. Therefore, the operation behaviors of the 5G BS will undergo a series of changes and be closely integrated with the decision of load recovery of the PDN after power outage, as shown in FIG. 5. Detailed analysis and modeling are given below.

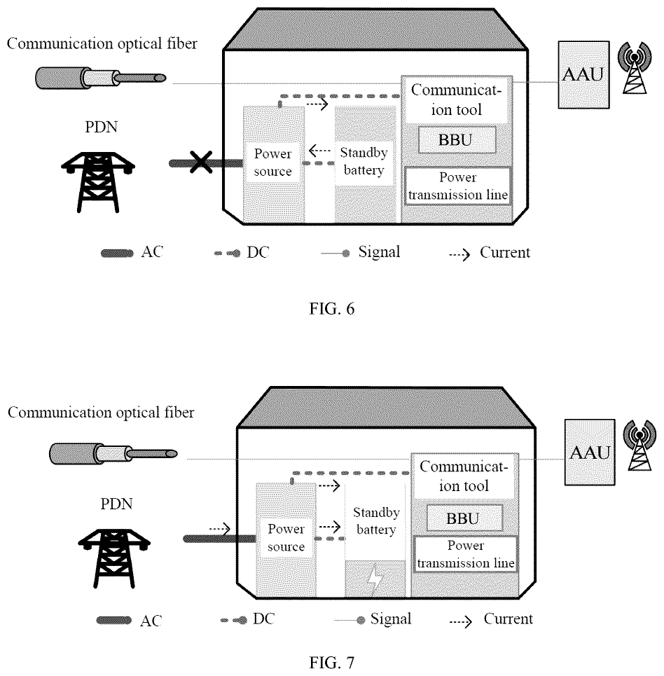

(1) In the first stage: when a power outage occurs, the power source will be switched to the standby battery to realize uninterrupted power supply. In order to maintain high reliability of communication services, the standby battery is used only to supply power to the 5G BS and not to provide energy storage services for the PDN. There is no power exchange between the 5G BS and the distribution network system, as shown in FIG. 6. The operation behavior of the standby battery in the first stage is subject to the following constraints. P_{i,t}^{dl} is charge-discharge power of the BS in the first stage, P_{i,t}^{d,max} is the maximum discharging power of the standby battery, z_{i,t}^{dl} is a discharging state of the standby battery in the first stage, s_{i,t}^{D} is a load state (1 represents power restoration, and 0 represents power outage), SOC_{i,t}^{l} is a charging state of the standby battery, ηᵢ^{d} represents discharging efficiency of the standby battery, SOCᵢ^{min} represents a minimum charge capacity of the standby battery, and SOCᵢ^{int} is an initial energy storage level of the standby battery,

$$0 \leq {P}_{i , t}^{d l} \leq {z}_{i , t}^{d l} \cdot {P}_{i}^{d , max} \qquad ( 5 a )$$

$${z}_{i , t}^{d l} \leq 1 - {s}_{i , t}^{D} \qquad ( 5 b )$$

$$S O {C}_{i , t + 1}^{l} = S O {C}_{i , t}^{l} - {P}_{i , t}^{d l} \cdot Δ t / {η}_{i}^{d} \qquad ( 5 c )$$

$$S O {C}_{i , t + 1}^{l} \geq S O {C}_{i}^{min} \qquad ( 5 d )$$

$$S O {C}_{i , 0}^{l} = S O {C}_{i}^{i n t} \qquad ( 5 e )$$

Formula (5b) indicates that the standby battery is operated only in the first stage.

In addition, the standby battery is only used to supply power to the 5G BS. Therefore, the power consumption of the 5G BS is to be equal to a discharging power of the standby battery. The following constraint conditions are to be satisfied, where M is a big number.

$$0 \leq {P}_{i , t}^{B} - {P}_{i , t}^{d l} \leq {s}_{i , t}^{D} \cdot M \qquad ( 5 f )$$

(2) In the second stage: once the power of a power grid is restored, the standby battery will be immediately charged to an original energy storage level. It is worth noting that a charging time of the standby battery is determined by a power outage time. This is because when the power outage time is long, the remaining electricity capacity of the standby battery decreases, and more time is required for charging. At this time, the electricity capacity supplied by the distribution network is a sum of the charging power for the communication BS power and the standby battery. The charging time and the power absorbed from the PDN depend on the outage time. Therefore, the operation behavior of the 5G BS is time-varying and closely related to the load recovery decision.

It is assumed that when the PDN resupplies power to the 5G BS, the standby battery will be charged to its initial energy storage level as quickly as possible. For simplicity, at this stage, the charging power of the standby battery remains unchanged, as shown in FIG. 7. An operation decision of the standby battery is described as (6). δᵢ is a load state in different time periods, Pᵢ^{c,max} is the maximum charging power of the standby battery, z_{i,t} is a schedulable state of the standby battery, and Pᵢ^{e} is charging power of the standby battery.

$${δ}_{i} = [ {s}_{i , 1}^{D} , {s}_{i , 2}^{D} - {s}_{i , 1}^{D} , … , {s}_{i , T}^{D} - {s}_{i , T - 1}^{D} ] \qquad ( 6 a )$$

$$S O {C}_{i , t}^{l} = [ S O {C}_{i , i}^{l} , S O {C}_{i , 2}^{l} , … , S O {C}_{i , t}^{l} , … , S O {C}_{i , T}^{l} ] \qquad ( 6 b )$$

$${δ}_{i} \cdot {( S O {C}_{i , t}^{l} )}^{T} + {P}_{i}^{c , max} {\sum }_{t ∈ T} ( {s}_{i , t}^{D} - {z}_{i , t} ) Δ t / {E}_{i} \geq S O {C}_{i}^{i n t} \qquad ( 6 c )$$

$${δ}_{i} \cdot {( S O {C}_{i , t}^{l} )}^{T} + {P}_{i}^{c , max} [ {\sum }_{t ∈ T} ( {s}_{i , t}^{D} - {z}_{i , t} ) - 1 ] Δ t / {E}_{i} \leq S O {C}_{i}^{i n t} \qquad ( 6 d )$$

$${P}_{i}^{e} {\sum }_{t ∈ T} ( {s}_{i , t}^{D} - {z}_{i , t} ) Δ t / {E}_{i} = S O {C}_{i}^{a} - {δ}_{i} \cdot {( S O {C}_{i , t}^{l} )}^{T} \qquad ( 6 e )$$

Formulas (6a) and (6b) are used to select an appropriate state of charge (SOC) for the standby battery at an initial time of the second stage. Formulas (6c) and (6d) ensure that the standby battery can be charged at the maximum power when it is re-energized. Formula (6e) indicates the charging power, and Pᵢ^{e} is fixed in the second stage.

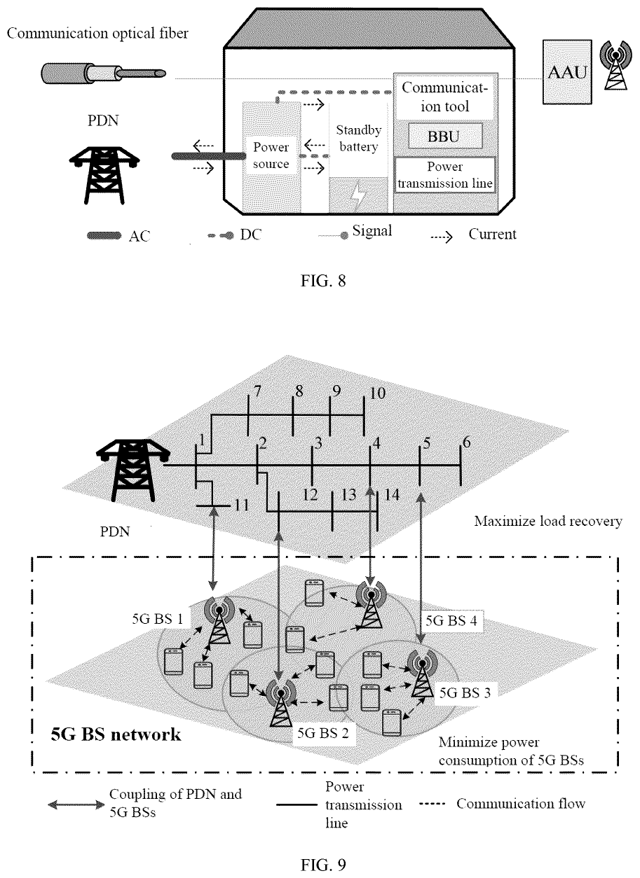

(3) In the third stage: after a period of continuous charging, the energy storage capacity of the standby battery reaches the original level. An additional energy storage portion of the standby battery may be used to supply energy to the distribution network (i. e. help restore the load) as compared to the minimum energy storage capacity, as shown in FIG. 8. The available time of the standby battery is to meet:

$${Z}_{i , t + 1} \geq {Z}_{i , t} \qquad ( 7 a )$$

$${Z}_{i , t + 1} \geq {Z}_{i , t} \qquad ( 7 b )$$

Formula (7a) indicates that the standby batteries can always be called once they are available. Formula (7b) indicates that the available time of the standby battery is to be later than a power-on time of the 5G BS.

The operation behavior of standby battery is to meet the following requirements. P_{i,t}^{cd} represents charge-discharge power of the standby battery of the BS in the third stage, P_{i,t}^{cu} and P_{i,t}^{du} represent charging and discharging power of the standby battery of the BS in the third stage, z_{i,t}^{cu} and z_{i,t}^{du} represent charge-discharge states of the standby battery in the third stage, and SOC_{i,t}^{u} represents a charging state of the standby battery in the third stage.

$${P}_{i , t}^{c d} = {P}_{i , t}^{c u} - {P}_{i , t}^{d u} \qquad ( 8 a )$$

$$0 \leq {P}_{i , t}^{c u} \leq {z}_{i , t}^{c u} \cdot {P}_{i}^{c , max} \qquad ( 8 b )$$

$$0 \leq {P}_{i , t}^{d u} \leq {z}_{i , t}^{d u} \cdot {P}_{i}^{d , max} \qquad ( 8 c )$$

$${z}_{i , t}^{c u} + {z}_{i , t}^{d u} \leq {Z}_{i , t} \qquad ( 8 d )$$

$$S O {C}_{i , 0}^{u} = S O {C}_{i}^{i n t} \qquad ( 8 e )$$

$$S O {C}_{i , t + 1}^{u} = S O {C}_{i , t}^{u} + {η}_{i}^{c} \cdot {P}_{i , t}^{c u} \cdot Δ t - {P}_{i , t}^{d u} \cdot Δ t / {η}_{i}^{d} \qquad ( 8 f )$$

$$S O {C}_{i , t}^{min \_ r} \leq S O {C}_{i , t + 1}^{u} \leq S O {C}_{i}^{max} \qquad ( 8 g )$$

$$S O {C}_{i , t}^{min \_ r} = {P}_{i , t}^{B} \cdot D / {E}_{i} \qquad ( 8 h )$$

$$S O {C}_{i , T}^{u} = S O {C}_{i}^{i n t} \qquad ( 8 i )$$

Formula (8d) indicates that the standby battery of BS operates only in the third stage. Formulas (8e) and (8i) indicate that an SOC of the standby battery is to be restored to the initial level. Formulas (8g) and (8h) indicate that in order to ensure the energy supply reliability, the minimum energy storage capacity is to be ensured.

The load recovery of PDN considering standby energy storage of 5G BS is modeled.

The operation behavior of 5G BS is closely related to the load recovery process in practice. At the same time, the decision of the load recovery is also affected by the changing load. The operation of PDN is deeply coupled with the behavior of 5G BS, and the operation of PDN is to meet the constraints of 5G BS. Therefore, the double-layer optimization model is used to describe the load recovery of PDN for 5G BS. The upper layer is to recover the load as soon as possible, and the lower layer is to optimize the operation behavior of the 5G BS, as shown in FIG. 9.

(1) Load recovery model of upper layer: the load recovery includes an objective function and constraint conditions. The objective function is to maximize the load recovered after a power outage, described as follows. w; is a load weighting coefficient:

$$max {Σ}_{t ∈ T} {Σ}_{i ∈ L} {ω}_{i} {s}_{i , t}^{D} ( {P}_{i , t}^{D} + {P}_{i , t}^{B} ) \qquad ( 9 )$$

The constraints include:
1) a power flow constraint A DistFlow model is used to describe distribution power flow constraints. U_{i,t} is a node voltage; rⱼᵢ and xⱼᵢ are a line impedance and a reactance, respectively; P_{ji,t}^{L} and Q_{ji,t}^{L} are active and reactive power of a line; I_{ji,t}^{L} is a current; Q_{ji,t}^{L}, Q_{i,t}^{PV}, Q_{k,t}^{L}, and Q_{i,t}^{G} are reactive power of the line, PV reactive power, reactive power of a line connected to the BS and reactive power of a distributed generator (DG), respectively:

$${U}_{i , t} = {U}_{j , t} - 2 ( {r}_{j i} {P}_{ji , t}^{L} + {x}_{j i} {Q}_{ji , t}^{L} ) + ( {r}_{j i}^{2} + {x}_{j i}^{2} ) {I}_{ji , t}^{L} \qquad ( 10 a )$$

$${I}_{ji , t}^{L} = \frac{{( {P}_{ji , t}^{L} )}^{2} + {( {Q}_{ji , t}^{L} )}^{2}}{{U}_{j , t}} \qquad ( 10 b )$$

$${P}_{ji , t}^{L} = {\sum }_{k ∈ K ( i , \cdot )} {P}_{k , t}^{L} + {s}_{i , t}^{D} {P}_{i , t}^{D} + {s}_{i , t}^{D} {P}_{i , t}^{B} + ( {s}_{i , t}^{D} - {z}_{i , t} ) {P}_{i}^{e} + {P}_{i , t}^{c d} + {P}_{i , t}^{P V} - {P}_{i , t}^{G} \qquad ( 10 c )$$

$${Q}_{ji , t}^{L} = {\sum }_{k ∈ K ( i , \cdot )} {Q}_{k , t}^{L} + {s}_{i , t}^{D} {Q}_{i , t}^{D} + {s}_{i , t}^{D} {Q}_{i , t}^{B} + ( {s}_{i , t}^{D} - {z}_{i , t} ) {P}_{i}^{e} + {Q}_{i , t}^{c d} - {Q}_{i , t}^{P V} - {Q}_{i , t}^{G} \qquad ( 10 d )$$

In formula (10c), s_{i,t}^{D}P_{i,t}^{B} represents power of the 5G BS to meet communication requirements in the second stage; (s_{i,t}^{D}−z_{i,t})Pᵢ^{e} is charging power of the standby battery in the second stage; P_{i,t}^{cd} is charging/discharging power of the standby battery in the third stage; and P_{i,t}^{B}, z_{i,t} and Pᵢ^{e} describe operation behaviors of the 5G BS and are determined in the lower layer function.
The formula (10b) is non-convex and the relaxation is:

$${I}_{ji , t}^{L} \geq \frac{{( {P}_{ji , t}^{L} )}^{2} + {( {Q}_{ji , t}^{L} )}^{2}}{{U}_{j , t}} \qquad ( 10 e )$$

2) a sequence constraint: continuous power supply being maintained during recovery once the load is energized:

$${s}_{i , t + 1}^{D} \geq {s}_{i , t}^{D} \qquad ( 11 )$$

3) a voltage constraint: a node voltage remaining within its constraint:

$${U}_{i}^{min} \leq {U}_{i , t} \leq {U}_{i}^{max} \qquad ( 12 )$$

4) a transmission line capacity constraint: power flow in a distribution network being constrained by line heat capacity:

$$- {P}_{k}^{L \_ max} \leq {P}_{k , t}^{L} \leq {P}_{k}^{L \_ max} \qquad ( 13 a )$$

$$- {Q}_{k}^{L \_ max} \leq {Q}_{k , t}^{L} \leq {Q}_{k}^{L \_ max} \qquad ( 13 b )$$

5) a substation capacity constraint: a recoverable capacity constraint of a substation being shown in the following formula, where Pₜ^{sub} and Qₜ^{sub} represent upper limits of active and reactive power of the BS:

$$0 \leq {P}_{1 , t}^{L} \leq {P}_{t}^{sub} , 0 \leq {Q}_{1 , t}^{L} \leq {Q}_{t}^{sub} \qquad ( 14 )$$

6) a PV constraint: PV active and reactive power being maintained as:

$${( {P}_{i , t}^{PV} )}^{2} + {( {Q}_{i , t}^{PV} )}^{2} \leq {( {S}_{i}^{PV} )}^{2} \qquad ( 15 )$$

7) a DG constraint: An operation constraint for the DG includes a DG capacity and a climbing constraint: where s_{i,t}^{G} represents a 0-1 variable of a DG state and Pᵢ^{ramp} represents a climbing constraint of the DG:

$$- {s}_{i , t}^{G} {P}_{i , t}^{G \_ min} \leq {P}_{i , t}^{G} \leq {s}_{i , t}^{G} {P}_{i , t}^{G \_ max} , i ∈ G \qquad ( 16 a )$$

$$- {s}_{i , t}^{G} {Q}_{i , t}^{G \_ min} \leq {Q}_{i , t}^{G} \leq {s}_{i , t}^{G} {Q}_{i , t}^{G \_ max} , i ∈ G \qquad ( 16 b )$$

$$- {P}_{i}^{ramp} \leq {P}_{i , t + 1}^{G} - {P}_{i , t}^{G} \leq {P}_{i}^{ramp} , i ∈ G \qquad ( 16 c )$$

8) an energy storage constraint. The standby battery of the 5G BS can be used for load recovery, subject to the constraints of (8a)-(8i).

The optimization model of upper layer is composed of the objective function (9), constraint conditions (10a)-(16c) (8a)-(8i) and decision variables {s_{i,t}^{D}, P_{i,t}^{cd}, P_{i,t}^{cu}, P_{i,t}^{du}, z_{i,t}^{cu}, z_{i,t}^{du}, SOC_{i,t}^{u}}.

An objective function of the lower layer 5G BS optimal scheduling model is designed to minimize power consumption of the 5G BS,

$$min {\sum }_{t ∈ T} {\sum }_{i ∈ L} {P}_{i , t}^{B} \qquad ( 17 )$$

having constraints:
1) a power consumption constraint of the 5G BS: formula (1) is non-linear and a large M method is used to solve this problem, in which P_{i,t}^{tr} represents transmission power of the 5G BS:

$${P}_{i , t}^{B} \leq {P}_{i , t}^{B , a} + γ {P}_{i , t}^{tr} + ( 1 - {ε}_{i , t} ) \cdot M \qquad ( 18 a )$$

$${P}_{i , t}^{B} \geq {P}_{i , t}^{B , a} + γ {P}_{i , t}^{tr} - ( 1 - {ε}_{i , t} ) \cdot M \qquad ( 18 b )$$

$${P}_{i , t}^{B} \leq {P}_{i , t}^{B , b} + {ε}_{i , t} \cdot M \qquad ( 18 c )$$

$${P}_{i , t}^{B} \geq {P}_{i , t}^{B , b} - {ε}_{i , t} \cdot M \qquad ( 18 d )$$

2) constraints of the standby battery in the first phase: the discharge of the standby battery supplies power to the 5G BS, which is described by (5a)-(5f);
3) constraints of the standby battery in the second phase: the standby battery is charged to an initial level, which is constrained by (6a)-(6e);
4) availability constraints of the standby battery in the third phase: the standby battery is only available when the 5G BS is re-energized, which is subject to the constraints of (7a)-(7b);
5) the BS transmission power constraint is as follows, where C_{i,m,t} represents a 0-1 variable of a connection state of a user;

$${P}_{i , t}^{tr} = {\sum }_{m ∈ {M}_{i}} {C}_{i , m , t} {P}_{i , m , t}^{tr} \qquad ( 19 a )$$

$${P}_{i , t}^{tr} \leq {P}^{max} \qquad ( 19 b )$$

$$Formulas ( 2 a ) and ( 2 b ) \qquad ( 19 c )$$

6) a BS bandwidth constraint: in which B represents a bandwidth, and B^{max} is the maximum BS bandwidth:

$${B}_{i , t} = {\sum }_{m ∈ {M}_{i}} {C}_{i , m , t} B \qquad ( 20 a )$$

$${B}_{i , t} \leq {B}^{max} \qquad ( 20 b )$$

7) a customer communication satisfaction constraint: where N₀ is a power spectral density,

$${S}_{i , m , t} = \frac{{P}_{i , m , t}^{tr}}{{N}_{0}} \qquad ( 21 a )$$

$${ϑ}_{i , m , t} = B {log}_{2} ( 1 + {S}_{i , m , t} ) \qquad ( 21 b )$$

$${ϑ}_{i , m , t} \geq {ϑ}_{i , m}^{min} {C}_{i , m , t} \qquad ( 21 c )$$

S_{i,m,t} is a signal-to-noise ratio (SNR) used for characterizing communication quality. The formula (21b) is to calculate a transmission speed according to the Shannon formula. Considering that the communication quality is to be guaranteed when the communication load migrates, a speed of client transmission is not to be lower than that of a minimum transmission channel.

The optimization model of lower layer is composed of an objective function (17), constraint conditions (18a)-(21c) (5a)-(5f) (6a)-(6e) (7a)-(7b) and decision variables {P_{i,t}^{B}, P_{i,t}^{tr}, ε_{i,t}, P_{i,t}^{dl}, z_{i,t}^{dl}, SOC_{i,t}^{l}, z_{i,t}, Pᵢ^{e}, C_{i,m,t}}.

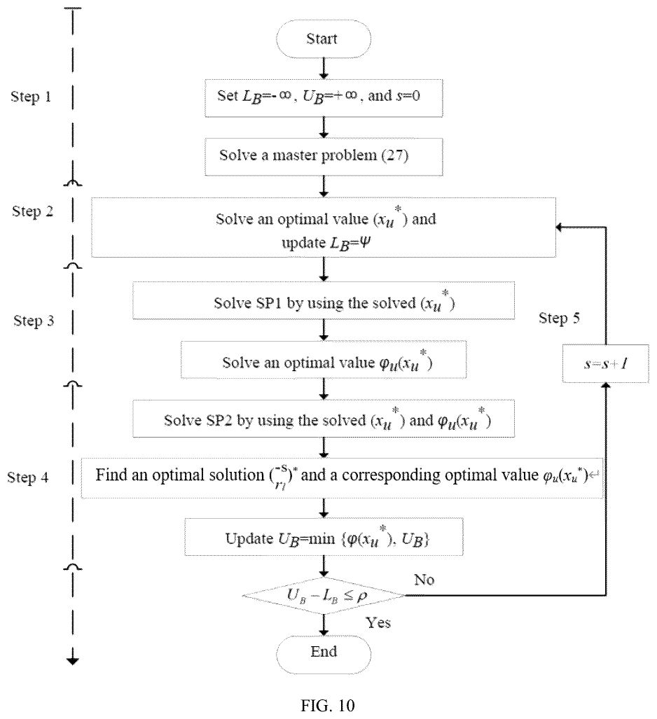

An algorithm for solving a double-layer mixed integer problem includes the formation of the double-layer mixed integer problem and the transformation of an original problem; and a solution flow is shown in FIG. 10.

Firstly, the formation of the double-layer mixed integer problem is described as follows.

$$min {ax}_{u} + {by}_{l} + {cr}_{l} \qquad ( 22 a )$$

$$s . t . {A}^{1} {x}_{u} + {V}^{1} {y}_{l} + {F}^{1} {r}_{l} = v \qquad ( 22 b )$$

$${A}^{2} {x}_{u} + {V}^{2} {y}_{l} + {F}^{2} {r}_{l} \leq m \qquad ( 22 c )$$

$$( {y}_{l} , {r}_{l} ) ∈ arg min \{ {dy}_{l} : \qquad ( 22 d )$$

$$s . t . {H}^{1} {x}_{u} + {J}^{1} {y}_{l} + {O}^{1} {r}_{l} = w \qquad ( 22 e )$$

$${H}^{2} {x}_{u} + {J}^{2} {y}_{l} + {O}^{2} {r}_{l} \leq h \qquad ( 22 f )$$

$${y}_{l} \geq 0 , {r}_{l} ∈ \{ 0 , 1 \} \qquad ( 22 g )$$

where xᵤ represents an upper layer decision variable appearing in a lower layer problem constraint condition; yₗ and rₗ are continuous and discrete decision variables at a lower layer, respectively, (22d)-(22f) represent the lower layer objective function and its original constraints, and a, b, c, A, V, F, v, m, w, h, H, J, O and d represent constant terms in a compact form of a primitive optimization problem.

Secondly, the model needs to be transformed to analyze the upper and lower layer problems separately. Assuming that when the upper layer decision variable is x, a unique optimal solution of a lower layer problem is y′ₗ and r′ₗ, the problem being reconstructed as follows:

$$min {ax}_{u} + {by}_{l}^{′} + {cr}_{l}^{′} \qquad ( 23 a )$$

$$s . t . {A}^{1} {x}_{u} + {V}^{1} {y}_{l}^{′} + {F}^{1} {r}_{l}^{′} = v \qquad ( 23 b )$$

$${A}^{2} {x}_{u} + {V}^{2} {y}_{l}^{′} + {F}^{2} {r}_{l}^{′} \leq m \qquad ( 23 c )$$

$${H}^{1} {x}_{u} + {J}^{1} {y}_{l}^{′} + {O}^{1} {r}_{l}^{′} = w \qquad ( 23 d )$$

$${H}^{2} {x}_{u} + {J}^{2} {r}_{l}^{′} + {O}^{2} {r}_{l}^{′} \leq h \qquad ( 23 e )$$

$${y}_{l}^{′} \geq 0 , {r}_{l}^{′} ∈ \{ 0 , 1 \} \qquad ( 23 f )$$

$${dy}_{l}^{′} \leq min \{ {dy}_{l} : \qquad ( 23 g )$$

$${H}^{1} {x}_{u} + {J}^{1} {y}_{l} + {O}^{1} {r}_{l} = w \qquad ( 23 h )$$

$${H}^{2} {x}_{u} + {J}^{2} {y}_{l} + {O}^{2} {r}_{l} = h \qquad ( 23 i )$$

$${y}_{l} \geq 0 , {r}_{l} ∈ \{ 0 , 1 \} \} \qquad ( 23 j )$$

To achieve the optimality condition of the LP to solve the lower layer problem, y and rₗ are separated by enumerating all possible values of a discrete decision variable rₗ and then a corresponding solution y is searched. Then lower layer problem being reorganized as follows:

$${dy}_{l}^{′} \leq min \{ d {\overline{y}}_{l} : \qquad ( 24 a )$$

$${H}^{1} {x}_{u} + {J}^{1} {\overline{y}}_{l} + {O}^{1} {\overline{r}}_{l} = w \qquad ( 24 b )$$

$${H}^{2} {x}_{u} + {J}^{2} {\overline{y}}_{l} + {O}^{2} {\overline{r}}_{l} \leq h \qquad ( 24 c )$$

$${\overline{y}}_{l} \geq 0 \} , ∀ {\overline{r}}_{l} ∈ r \qquad ( 24 d )$$

where r represents a set of rₗ; and although a radix of r is large, the second optimization is a pure LP problem when rₗ is fixed. Next, two sub-problems and a master problem are set to solve the model using the CCG method:

$$SP 1 : {φ}_{l} ( {x}_{u}^{*} ) = min {dy}_{l} \qquad ( 25 a )$$

$$s . t . {H}^{1} {x}_{u}^{*} + {J}^{1} {y}_{l} + {O}^{1} {r}_{l} = w : {χ}_{1} \qquad ( 25 b )$$

$${H}^{2} {x}_{u}^{*} + {J}^{2} {y}_{l} + {O}^{2} {r}_{l} \leq h : {μ}_{l} \qquad ( 25 c )$$

$${y}_{l} \geq 0 , {r}_{l} ∈ r \qquad ( 25 d )$$

Here (25b)-(25c) can be replaced with the KKT condition to set its dual variable X₁ and μₗ. A main model is seen below for specific transformation forms. Since SP1 can solve multiple solutions, SP2 is set to characterize the upper model:

$$SP 2 : {φ}_{u} ( {x}_{u}^{*} ) = min {ax}_{u}^{*} + {by}_{l} + {cr}_{l} \qquad ( 26 a )$$

$$s . t . ( 25 b ) - ( 25 d ) , {dy}_{l} \leq {φ}_{l} ( {x}_{u}^{*} ) \qquad ( 26 b )$$

Next, the master problem is set. Based on (23)-(24), the master problem is transformed by the duplication of the lower layer variables and constraint conditions, the specific value substitution of the lower layer problem, and the addition of the KKT condition. A compact model of the master problem is as follows:

$$ψ = min {ax}_{u} + {by}_{l}^{′} + {cr}_{l}^{′} \qquad ( 27 a )$$

$$s . t . ( 23 b ) - ( 23 f ) \qquad ( 27 b )$$

$${H}^{1} {x}_{u} + {J}^{1} {\hat{y}}_{l} + {O}^{1} {\hat{r}}_{l} = w \qquad ( 27 c )$$

$${dy}_{l}^{′} \leq d {\hat{y}}_{l} \qquad ( 27 d )$$

$$0 \leq {μ}_{l} ⊥ h - ( {H}^{2} {x}_{u} + {J}^{2} {\hat{y}}_{l} + {O}^{2} {\hat{r}}_{l} ) \geq 0 \qquad ( 27 e )$$

$$0 \leq {\hat{y}}_{l} ⊥ d + {J}^{1} {χ}_{l} + {J}^{2} {μ}_{l} \geq 0. \qquad ( 27 f )$$

For computational convenience, (27) can be linearized using the big-M method and bivariate. The convergence can be achieved by the limited tolerance between the dynamic upper and lower bounds provided by the sub-problems and the master problem.

Yet another example of the present disclosure provides a load recovery system for a PDN considering standby energy storage of 5G BSs is provided, including:
a model construction module, configured to construct a basic model of a 5G BS, including constructing an energy consumption model of the 5G BS on the basis of a 5G BS composition structure and a working state, and establishing a coordinated operation model among 5G BSs on the basis of the distribution of the 5G BSs, in which the 5G BS composition structure includes electric power supply and a communication device, the electric power supply including a power source and a standby battery;
an evaluation module, configured to evaluate a schedulable capacity of the standby battery of the 5G BS, including calculating a minimum standby capacity of the standby battery, and evaluating a charging state of the standby battery;
a processing module, configured to model operation behaviors of the 5G BS at different stages after a power outage of the PDN, in which the different stages include: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level;
an optimization module, configured to use a double-layer optimization model to describe the load recovery of the PDN for the 5G BS on the basis of the correlation between the operation behaviors of the 5G BS and a load recovery process in practice, in which the double-layer optimization model includes an upper layer load recovery model and a lower layer 5G BS optimal scheduling model; and
a solution module, configured to solve the double-layer optimization model to complete the load recovery of a PDN system.

Examples of the present application may be provided as a method or computer program product. Therefore, the present application may take the form of an entirely hardware example, an entirely software example or an example combining software and hardware aspects. Moreover, the present application can take the form of a computer program product implemented on one or more computer-usable storage media (including, but not limited to, magnetic disk storage, compact disc read-only memory (CD-ROM), optical storage, etc.) having computer-usable program codes contained therein. The solutions in the examples of the present application may be implemented in various computer languages, such as the object-oriented programming language Java, the transliteration scripting language JavaScript, etc.

The present application is described with reference to flow charts and/or block diagrams of methods, devices (systems), and computer program products according to the examples of the present application. It is to be understood that each of flows and/or blocks of flow charts and/or block diagrams, and combinations of flows and/or blocks in the flow charts and/or block diagrams, can be implemented by computer program instructions. These computer program instructions may be provided to a processor of a general purpose computer, special purpose computer, embedded processor, or other programmable data processing device to produce a machine, so that the instructions, which, when executed by a processor of the computer or other programmable data processing device, produce an apparatus for implementing the functions specified in the flow or flows of the flow chart and/or the block or blocks of the block diagram.

These computer program instructions may also be stored in a computer-readable memory that can direct a computer or other programmable data processing devices to function in a particular manner, such that the instructions stored in the computer-readable memory produce an article of manufacture including instruction apparatuses which implement the function specified in the flow or flows of the flowchart and/or the block or blocks of the block diagram.

These computer program instructions may also be loaded onto a computer or other programmable data processing devices to cause a series of operational steps to be performed on the computer or other programmable devices to produce a computer implemented process, so that the instructions, which, when executed on the computer or other programmable devices, provide steps for implementing the functions specified in the flow or flows of the flow charts and/or the block or blocks of the block diagram.

It is to be noted that in this specification, relational terms such as “first” and “second” are only used to distinguish one entity or operation from another entity or operation, and do not necessarily require or imply that there is any such an actual relationship or order between these entities or operations. Moreover, the terms “including”, “containing” or any other variations are intended to cover non-exclusive inclusion, so that a process, method, article or device including a series of elements includes not only those elements, but also other elements not explicitly listed or elements inherent to such a process, method, article or device. Without further restrictions, an element defined by the phrase “including one” does not exclude the existence of other identical elements in the process, method, article or device including the element.

1. A load recovery method for a power distribution network (PDN) considering standby energy storage of 5G base stations (BSs), comprising:
constructing a basic model of a 5G BS, comprising constructing an energy consumption model of the 5G BS on the basis of a 5G BS composition structure and a working state, and establishing a coordinated operation model among 5G BSs on the basis of the distribution of the 5G BSs, wherein the 5G BS composition structure comprises electric power supply and a communication device, the electric power supply comprising a power source and a standby battery;
evaluating a schedulable capacity of the standby battery of the 5G BS, comprising calculating a minimum standby capacity of the standby battery, and evaluating a charging state of the standby battery;
modeling operation behaviors of the 5G BS at different stages after a power outage of the PDN, wherein the different stages comprise: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level;
using a double-layer optimization model to describe the load recovery of the PDN for the 5G BS on the basis of the correlation between the operation behaviors of the 5G BS and a load recovery process in practice, wherein the double-layer optimization model comprises an upper layer load recovery model and a lower layer 5G BS optimal scheduling model; and
solving the double-layer optimization model to complete the load recovery of a PDN system.

2. The load recovery method for a PDN considering standby energy storage of 5G BSs according to claim 1, wherein the energy consumption model of the 5G BS is as follows:
$${P}_{i , t}^{B} = \{ \begin{matrix}{P}_{i , t}^{B , a} + γ {P}_{i , t}^{tr} , {ε}_{i , t} = 1 ( active ) \\ {P}_{i , t}^{B , b} , {ε}_{i , t} = 0 ( sleep )\end{matrix}$$
where P_{i,t}^{B} refers to power consumption of the 5G BS in a t period, P_{i,t}^{tr} represents transmission power, ε_{i,t} represents a state, γ represents a constant term coefficient, and a constraint P_{i,t}^{B,a}>P_{i,t}^{B,b} exists, representing that power consumption of the 5G BS in a sleep mode is much less than that in an active mode.

3. The load recovery method for a PDN considering standby energy storage of 5G BSs according to claim 2, wherein the construction of the coordinated operation model among the 5G BSs is as follows:
transferring a communication load among multiple 5G BSs to realize power migration, the connection between a client and the 5G BS being constrained in the migration process:
$${\sum }_{i ϵ {I}_{m}} {C}_{i , m , t} = 1$$
$${C}_{i , m , t} \leq {ε}_{i , t}$$
where C_{i,m,t} refers to a connection state of the client.

4. The load recovery method for a PDN considering standby energy storage of 5G BSs according to claim 3, wherein the calculating a minimum standby capacity of the standby battery specifically comprises:
$${R}_{i , t} = {\int }_{t}^{t + D} {P}_{i , t}^{B} dt$$
$${R}_{i , t} = {P}_{i , t}^{B} \cdot D$$
where R_{i,t} is the minimum standby energy of the standby battery, and D is a standby duration.

5. The load recovery method for a PDN considering standby energy storage of 5G BSs according to claim 4, wherein the evaluating a charging state of the standby battery specifically comprises:
defining the charging state of the standby battery according to a remaining capacity R_{i,t} of the standby battery and a maximum capacity Eᵢ of the standby battery, SOC_{i,t}^{min} being subject to:
$$S O {C}_{i , t}^{min} = {R}_{i , t} / {E}_{i} .$$

6. The load recovery method for a PDN considering standby energy storage of 5G BSs according to claim 5, wherein in the first stage, the operation behavior of the standby battery is constrained by:
$$0 \leq {P}_{i , t}^{d l} \leq {z}_{i , t}^{d l} \cdot {P}_{i}^{d , max}$$
$${z}_{i , t}^{d l} \leq 1 - {s}_{i , t}^{D}$$
$$S O {C}_{i , t + 1}^{l} = S O {C}_{i , t}^{l} - {P}_{i , t}^{d l} \cdot Δ t / {η}_{i}^{d}$$
$$S O {C}_{i , t + 1}^{l} \geq S O {C}_{i}^{min}$$
$$S O {C}_{i , 0}^{l} = S O {C}_{i}^{i n t}$$
where P_{i,t}^{dl} is charge-discharge power of the BS in the first stage, Pᵢ^{d,max} is the maximum discharging power of the standby battery, z_{i,t}^{dl} is a discharging state of the standby battery in the first stage, s_{i,t}^{D} is a load state, SOC_{i,t}^{l} is a charging state of the standby battery, ηᵢ^{d} represents discharging efficiency of the standby battery, SOCᵢ^{min} represents a minimum charge capacity of the standby battery, and SOCᵢ^{int} is an initial energy storage level of the standby battery,
$$0 \leq {P}_{i , t}^{B} - {P}_{i , t}^{d l} \leq {s}_{i , t}^{D} \cdot M$$
where M is a big number;
in the second stage, operation decisions of the standby battery are described as follows:
$${δ}_{i} = [ {s}_{i , 1}^{D} , {s}_{i , 2}^{D} - {s}_{i , 1}^{D} , … , {s}_{i , T}^{D} - {s}_{i , T - 1}^{D} ]$$
$$S O {C}_{i , t}^{l} = [ S O {C}_{i , 1}^{l} , S O {C}_{i , 2}^{l} , … , S O {C}_{i , t}^{l} , … , S O {C}_{i , T}^{l} ]$$
$${δ}_{i} \cdot {( S O {C}_{i , t}^{l} )}^{T} + {P}_{i}^{c , max} {\sum }_{t ∈ T} ( {s}_{i , t}^{D} - {z}_{i , t} ) Δ t / {E}_{i} \geq S O {C}_{i}^{i n t}$$
$${δ}_{i} \cdot {( S O {C}_{i , t}^{l} )}^{T} + {P}_{i}^{c , max} [ {\sum }_{t ∈ T} ( {s}_{i , t}^{D} - {z}_{i , t} ) - 1 ] Δ t / {E}_{i} \leq S O {C}_{i}^{i n t}$$
$${P}_{i}^{e} {\sum }_{t ∈ T} ( {s}_{i , t}^{D} - {z}_{i , t} ) Δ t / {E}_{i} = S O {C}_{i}^{a} - {δ}_{i} \cdot {( S O {C}_{i , t}^{l} )}^{T}$$
where δᵢ is a load state in different time periods, Pᵢ^{c,max} is the maximum charging power of the standby battery, z_{i,t} is a schedulable state of the standby battery, and Pᵢ^{e} is charging power of the standby battery; and
in the third stage, an available time of the standby battery is as follows:
$${Z}_{i , t + 1} \geq {Z}_{i , t}$$
$${Z}_{i , t} \leq {s}_{i , t}^{D}$$
in which the operation behavior of the standby battery meets the following requirements:
$${P}_{i , t}^{c d} = {P}_{i , t}^{c u} - {P}_{i , t}^{d u}$$
$$0 \leq {P}_{i , t}^{c u} \leq {z}_{i , t}^{c u} \cdot {P}_{i}^{c , max}$$
$$0 \leq {P}_{i , t}^{d u} \leq {z}_{i , t}^{d u} \cdot {P}_{i}^{d , max}$$
$${z}_{i , t}^{c u} + {z}_{i , t}^{d u} \leq {Z}_{i , t}$$
$$S O {C}_{i , 0}^{u} = S O {C}_{i}^{i n t}$$
$$S O {C}_{i , t + 1}^{u} = S O {C}_{i , t}^{u} + {η}_{i}^{c} \cdot {P}_{i , t}^{c u} \cdot Δ t - {P}_{i , t}^{d u} \cdot Δ t / {η}_{i}^{d}$$
$$S O {C}_{i , t}^{min \_ r} \leq S O {C}_{i , t + 1}^{u} \leq S O {C}_{i}^{max}$$
$$S O {C}_{i , t}^{min \_ r} = {P}_{i , t}^{B} \cdot D / {E}_{i}$$
$$S O {C}_{i , T}^{u} = S O {C}_{i}^{i n t}$$
where P_{i,t}^{cd} represents charge-discharge power of the standby battery of the BS in the third stage, P_{i,t}^{cu} and P_{i,t}^{du} represent charging and discharging power of the standby battery of the BS in the third stage, z_{i,t}^{cu} and z_{i,t}^{du} represent charge-discharge states of the standby battery in the third stage, and SOC_{i,t}^{u} represents a charging state of the standby battery in the third stage.

7. The load recovery method for a PDN considering standby energy storage of 5G BSs according to claim 6, wherein the construction of the upper layer load recovery model is specifically as follows:
the load recovery comprising an objective function and constraint conditions, the objective function being to maximize the load recovered after the power outage:
$$max {\sum }_{t ∈ T} {\sum }_{i ∈ L} {ω}_{i} {s}_{i , t}^{D} ( {P}_{i , t}^{D} + {P}_{i , t}^{B} )$$
where ωᵢ is a load weighting coefficient; and
the constraint conditions comprising:
a power flow constraint:
$${U}_{i , t} = {U}_{j , t} - 2 ( {r}_{j i} {P}_{ji , t}^{L} + {x}_{j i} {Q}_{ji , t}^{L} ) + ( {r}_{j i}^{2} + {x}_{j i}^{2} ) {I}_{ji , t}^{L}$$
$${I}_{ji , t}^{L} = \frac{{( {P}_{ji , t}^{L} )}^{2} + {( {Q}_{ji , t}^{L} )}^{2}}{{U}_{j , t}}$$
$${P}_{ji , t}^{L} = {\sum }_{k ∈ K ( i , \cdot )} {P}_{k , t}^{L} + {s}_{i , t}^{D} {P}_{i , t}^{D} + {s}_{i , t}^{D} {P}_{i , t}^{B} + ( {s}_{i , t}^{D} - {z}_{i , t} ) {P}_{i}^{e} + {P}_{i , t}^{c d} + {P}_{i , t}^{P V} - {P}_{i , t}^{G}$$
$${Q}_{ji , t}^{L} = {\sum }_{k ∈ K ( i , \cdot )} {Q}_{k , t}^{L} + {s}_{i , t}^{D} {Q}_{i , t}^{D} + {s}_{i , t}^{D} {Q}_{i , t}^{B} + ( {s}_{i , t}^{D} - {z}_{i , t} ) {P}_{i}^{e} + {Q}_{i , t}^{c d} - {Q}_{i , t}^{P V} - {Q}_{i , t}^{G}$$
where U_{i,t} is a node voltage; It and xx are a line impedance and a reactance, respectively; P_{ji,t}^{L} and Q_{ji,t}^{L} are active and reactive power of a line; I_{ji,t}^{L} is a current; Q_{ji,t}^{L}, Q_{i,t}^{PV}, Q_{k,t}^{L}, and Q_{i,t}^{G} are reactive power of the line, photovoltaic (PV) reactive power, reactive power of a line connected to the BS and reactive power of a distributed generator (DG), respectively; s_{i,t}P_{i,t}^{B} represents power of the 5G BS; (s_{i,t}^{D}−z_{i,t})Pᵢ^{e} is charging power of the standby battery in the second stage; P_{i,t}^{cd} is charging/discharging power of the standby battery in the third stage; and P_{i,t}^{B}, z_{i,t} and Pᵢ^{e} describe operation behaviors of the 5G BS;
a formula
$${I}_{ji , t}^{L} = \frac{{( {P}_{ji , t}^{L} )}^{2} + {( {Q}_{ji , t}^{L} )}^{2}}{{U}_{j , t}}$$
being non-convex and the relaxation being:
$${I}_{ji , t}^{L} \geq \frac{{( {P}_{ji , t}^{L} )}^{2} + {( {Q}_{ji , t}^{L} )}^{2}}{{U}_{j , t}}$$
a sequence constraint: continuous power supply being maintained during recovery once the load is energized:
$${s}_{i , t + 1}^{D} \geq {s}_{i , t}^{D}$$
a voltage constraint: a node voltage remaining within its constraint:
$${U}_{i}^{min} \leq {U}_{i , t} \leq {U}_{i}^{max}$$
a transmission line capacity constraint: power flow in a distribution network being constrained by line heat capacity:
$$- {P}_{k}^{L \_ max} \leq {P}_{k , t}^{L} \leq {P}_{k}^{L \_ max} \\ - {Q}_{k}^{L \_ max} \leq {Q}_{k , t}^{L} \leq {Q}_{k}^{L \_ max}$$
a substation capacity constraint: a recoverable capacity constraint of a substation being shown in the following formula, where Pₜ^{sub} and Qₜ^{sub} represent upper limits of active and reactive power of the BS:
$$0 \leq {P}_{1 , t}^{L} \leq {P}_{t}^{sub} , 0 \leq {Q}_{1 , t}^{L} \leq {Q}_{t}^{sub}$$
a PV constraint: PV active and reactive power being maintained as:
$${( {P}_{i , t}^{PV} )}^{2} + {( {Q}_{i , t}^{PV} )}^{2} \leq {( {S}_{i}^{PV} )}^{2}$$
a DG constraint: an operation constraint for the DG comprising a DG capacity and a climbing constraint:
$$- {s}_{i , t}^{G} {P}_{i , t}^{G \_ min} \leq {P}_{i , t}^{G} \leq {s}_{i , t}^{G} {P}_{i , t}^{G \_ max} , i ∈ G \\ - {s}_{i , t}^{G} {Q}_{i , t}^{G \_ min} \leq {Q}_{i , t}^{G} \leq {s}_{i , t}^{G} {Q}_{i , t}^{G \_ max} , i ∈ G \\ - {P}_{i}^{ramp} \leq {P}_{i , t + 1}^{G} - {P}_{i , t}^{G} \leq {P}_{i}^{ramp} , i ∈ G$$
where s_{i,t}^{G} represents a 0-1 variable of a DG state, and Pᵢ^{ramp} represents a climbing constraint of the DG; and
an energy storage constraint.

8. The load recovery method for a PDN considering standby energy storage of 5G BSs according to claim 6, wherein an objective function of the lower layer 5G BS optimal scheduling model is designed to minimize power consumption of the 5G BS,
$$min {\sum }_{t ∈ T} {\sum }_{i ∈ L} {P}_{i , t}^{B}$$
having constraint conditions:
a power consumption constraint of the 5G BS:
$${P}_{i , t}^{B} \leq {P}_{i , t}^{B , a} + γ {P}_{i , t}^{tr} + ( 1 - {ε}_{i , t} ) \cdot M \\ {P}_{i , t}^{B} \geq {P}_{i , t}^{B , a} + γ {P}_{i , t}^{tr} - ( 1 - {ε}_{i , t} ) \cdot M \\ {P}_{i , t}^{B} \leq {P}_{i , t}^{B , b} + {ε}_{i , t} \cdot M \\ {P}_{i , t}^{B} \geq {P}_{i , t}^{B , b} - {ε}_{i , t} \cdot M$$
where P_{i,t}^{tr} represents transmission power of the 5G BS;
a BS transmission power constraint:
$${P}_{i , t}^{tr} = {\sum }_{m ∈ {M}_{i}} {C}_{i , m , t} {P}_{i , m , t}^{tr} \\ {P}_{i , t}^{tr} \leq {P}^{max} \\ {\sum }_{i ∈ {I}_{m}} {C}_{i , m , t} = 1 \\ {C}_{i , m , t} \leq {ε}_{i , t}$$
where C_{i,m,t} represents a 0-1 variable of a connection state of a user;
a BS bandwidth constraint:
$${B}_{i , t} = {\sum }_{m ∈ {M}_{i}} {C}_{i , m , t} B \\ {B}_{i , t} \leq {B}^{max}$$
where B represents a bandwidth, and B^{max} is the maximum BS bandwidth; and
a customer communication satisfaction constraint:
$${S}_{i , m , t} = \frac{{P}_{i , m , t}^{tr}}{{N}_{0}} \\ {ϑ}_{i , m , t} = B {log}_{2} ( 1 + {S}_{i , m , t} ) \\ {ϑ}_{i , m , t} \geq {ϑ}_{i , m}^{min} {C}_{i , m , t}$$
where N₀ is a power spectral density, and S_{i,m,t} is a signal-to-noise ratio (SNR) used for characterizing communication quality.

9. The load recovery method for a PDN considering standby energy storage of 5G BSs according to claim 7, wherein the solving the double-layer optimization model to complete the load recovery of a PDN system specifically comprises:
the double-layer optimization model being:
$$min {ax}_{u} + {by}_{l} + {cr}_{l} \\ s . t . {A}^{1} {x}_{u} + {V}^{1} {y}_{l} + {F}^{1} {r}_{l} = v \\ {A}^{2} {x}_{u} + {V}^{2} {y}_{l} + {F}^{2} {r}_{l} \leq m \\ ( {y}_{l} , {r}_{l} ) ∈ arg min \{ {dy}_{l} : \\ s . t . {H}^{1} {x}_{u} + {J}^{1} {y}_{l} + {O}^{1} {r}_{l} = w \\ {H}^{2} {x}_{u} + {J}^{2} {y}_{l} + {O}^{2} {r}_{l} \leq h \\ {y}_{l} \geq 0 , {r}_{l} ∈ \{ 0 , 1 \}$$
where xᵤ represents an upper layer decision variable appearing in a lower layer problem constraint condition; yₗ and rₗ are continuous and discrete decision variables at a lower layer, respectively; and a, b, c, A, V, F, v, m, w, h, H, J, O and d represent constant terms in a compact form of the optimization model;
assuming that when the upper layer decision variable is x, a unique optimal solution of a lower layer problem is y′ₗ and r′ₗ, the problem being reconstructed as follows:
$$min {ax}_{u} + {by}_{l}^{′} + {cr}_{l}^{′} \\ s . t . {A}^{1} {x}_{u} + {V}^{1} {y}_{l}^{′} + {F}^{1} {r}_{l}^{′} = v \\ {A}^{2} {x}_{u} + {V}^{2} {y}_{l}^{′} + {F}^{2} {r}_{l}^{′} \leq m \\ {H}^{1} {x}_{u} + {J}^{1} {y}_{l}^{′} + {O}^{1} {r}_{l}^{′} = w \\ {H}^{2} {x}_{u} + {J}^{2} {r}_{l}^{′} + {O}^{2} {r}_{l}^{′} \leq h \\ {y}_{l}^{′} \geq 0 , {r}_{l}^{′} ∈ \{ 0 , 1 \} \\ {dy}_{l}^{′} \leq min \{ {dy}_{l} : \\ {H}^{1} {x}_{u} + {J}^{1} {y}_{l} + {O}^{1} {r}_{l} = w \\ {H}^{2} {x}_{u} + {J}^{2} {y}_{l} + {O}^{2} {r}_{l} = h \\ {y}_{l} \geq 0 , {r}_{l} ∈ \{ 0 , 1 \} \}$$
the lower layer problem being reorganized as follows:
$${dy}_{l}^{′} \leq min \{ d {\overline{y}}_{l} : \\ {H}^{1} {x}_{u} + {J}^{1} {\overline{y}}_{l} + {O}^{1} {\overline{r}}_{l} = w \\ {H}^{2} {x}_{u} + {J}^{2} {\overline{y}}_{l} + {O}^{2} {\overline{r}}_{l} \leq h \\ {\overline{y}}_{l} \geq 0 \} , ∀ {\overline{r}}_{l} ∈ r$$
where r represents a set of rₗ;
$$SP 1 : {φ}_{l} ( {x}_{u}^{*} ) = min {dy}_{l} \\ s . t . {H}^{1} {x}_{u}^{*} + {J}^{1} {y}_{l} + {O}^{1} {r}_{l} = w : {χ}_{1} \\ {H}^{2} {x}_{u}^{*} + {J}^{2} {y}_{l} + {O}^{2} {r}_{l} \leq h : {μ}_{l} \\ {y}_{l} \geq 0 , {r}_{l} ∈ r$$
SP2 being set to characterize an upper layer model:
$$SP 2 : {φ}_{u} ( {x}_{u}^{*} ) = min {ax}_{u}^{*} + {by}_{l} + {cr}_{l} \\ s . t . {H}^{1} {x}_{u}^{*} + {J}^{1} {y}_{l} + {O}^{1} {r}_{l} = w : {χ}_{1} \\ {H}^{2} {x}_{u}^{*} + {J}^{2} {y}_{l} + {O}^{2} {r}_{l} \leq h : {μ}_{l} \\ {y}_{l} \geq 0 , {r}_{l} ∈ r , {dy}_{l} \leq {φ}_{l} ( {x}_{u}^{*} ) ;$$
the transformation being performed by the duplication of a lower layer variable and constraint conditions, the specific value substitution of the lower layer problem and the addition of Karush-Kuhn-Tucker (KKT) conditions:
$$ψ = min {ax}_{u} + {by}_{l}^{′} + {cr}_{l}^{′} \\ s . t . {A}^{1} {x}_{u} + {V}^{1} {y}_{l}^{′} + {F}^{1} {r}_{l}^{′} = v \\ {A}^{2} {x}_{u} + {V}^{2} {y}_{l}^{′} + {F}^{2} {r}_{l}^{′} \leq m \\ {H}^{1} {x}_{u} + {J}^{1} {y}_{l}^{′} + {O}^{1} {r}_{l}^{′} = w \\ {H}^{2} {x}_{u} + {J}^{2} {r}_{l}^{′} + {O}^{2} {r}_{l}^{′} \leq h \\ {y}_{l}^{′} \geq 0 , {r}_{l}^{′} ∈ \{ 0 , 1 \} \\ {dy}_{l}^{′} \leq min \{ {dy}_{l} : \\ {H}^{1} {x}_{u} + {J}^{1} {y}_{l} + {O}^{1} {r}_{l} = w \\ {H}^{2} {x}_{u} + {J}^{2} {y}_{l} + {O}^{2} {r}_{l} = h \\ {y}_{l} \geq 0 , {r}_{l} ∈ \{ 0 , 1 \} \} \\ {H}^{1} {x}_{u} + {J}^{1} {\hat{y}}_{l} + {O}^{1} {\hat{r}}_{l} = w \\ {dy}_{l}^{′} \leq d {\hat{y}}_{l} \\ 0 \leq {μ}_{l} ⊥ h - ( {H}^{2} {x}_{u} + {J}^{2} {\hat{y}}_{l} + {O}^{2} {\hat{r}}_{l} ) \geq 0 \\ 0 \leq {\hat{y}}_{l} ⊥ d + {J}^{1} {χ}_{l} + {J}^{2} {μ}_{l} \geq 0.$$

10. A load recovery system for a PDN considering standby energy storage of 5G BSs, comprising:
a model construction module, configured to construct a basic model of a 5G BS, comprising constructing an energy consumption model of the 5G BS on the basis of a 5G BS composition structure and a working state, and establishing a coordinated operation model among 5G BSs on the basis of the distribution of the 5G BSs, wherein the 5G BS composition structure comprises electric power supply and a communication device, the electric power supply comprising a power source and a standby battery;
an evaluation module, configured to evaluate a schedulable capacity of the standby battery of the 5G BS, comprising calculating a minimum standby capacity of the standby battery, and evaluating a charging state of the standby battery;
a processing module, configured to model operation behaviors of the 5G BS at different stages after a power outage of the PDN, wherein the different stages comprise: in the first stage: when a power outage occurs, the power source is switched to the standby battery to realize uninterrupted power supply; in the second stage: when the power of a power grid is restored, the standby battery is immediately charged to an original energy storage level; and in the third stage: after continuous charging for a period of time, an energy storage capacity of the standby battery reaches the original level;
an optimization module, configured to use a double-layer optimization model to describe the load recovery of the PDN for the 5G BS on the basis of the correlation between the operation behaviors of the 5G BS and a load recovery process in practice, wherein the double-layer optimization model comprises an upper layer load recovery model and a lower layer 5G BS optimal scheduling model; and
a solution module, configured to solve the double-layer optimization model to complete the load recovery of a PDN system.
